(19) United States
(12) Patent Application Publication
(10) Pub. No.: US 2024/0078582 A1
(43) Pub. Date: Mar. 7, 2024

(54) SYSTEM, METHOD, AND APPARATUS FOR THE INTEGRATED SALE AND RENTAL OF PRODUCTS

(71) Applicants: Brian P. Fulkerson, Roseville, CA (US); Jourdin K. Blackman, Roseville, CA (US)

(72) Inventors: Brian P. Fulkerson, Roseville, CA (US); Jourdin K. Blackman, Roseville, CA (US)

(21) Appl. No.: 17/939,550

(22) Filed: Sep. 7, 2022

(51) Int. Cl. G06Q 30/06; G06Q 20/18; G06Q 20/32

(52) U.S. Cl. CPC G06Q 30/0621; G06Q 20/18; G06Q 20/322

(57) ABSTRACT

A self-service vending machine, system, and method for the integrated sale and rental of specialized equipment is provided. Namely, a storage means may be configured to house a rental product and non-rental product, a delivery means, a receiving means, a user interface, and communication means operative to carry out the method. The method may comprise the steps of receiving a transaction request, displaying at least one customization option, and customizing a transaction. The customization option may include a rental period length, any products included in the transaction, and add-ons such as additional products or insurance. The communication means may carry out the steps of authenticating a user's identity, calculating a transaction fee, receiving a payment, and delivering, through the delivery means, the rental and non-rental product. Further, the communication means may facilitate returning the rental product following the end of the rental period.

### GOVERNMENT CONTRACT

Not applicable.

### CROSS-REFERENCE TO RELATED APPLICATIONS

Not applicable.

### STATEMENT RE. FEDERALLY SPONSORED RESEARCH/DEVELOPMENT

Not applicable.

### COPYRIGHT & TRADEMARK NOTICES

A portion of the disclosure of this patent document may contain material which is subject to copyright protection. This patent document may show and/or describe matter which is or may become trade dress of the owner. The copyright and trade dress owner has no objection to the facsimile reproduction by any one of the patent document or the patent disclosure, as it appears in the Patent and Trademark Office patent files or records, but otherwise reserves all copyrights and trade dress rights whatsoever.

### TECHNICAL FIELD

The disclosed subject matter relates generally to a system, method, and apparatus for the sale and rental of specialized equipment, and more particularly, to a fully integrated system for the simultaneous and customizable sale and rental of specialized equipment such as action cameras.

### BACKGROUND

Specialized equipment is available to consumers on the marketplace in many fields and for use in countless contexts. For example, action cameras designed to record activities while a user is immersed in such activities allow consumers to capture photos and videos in environments where other cameras or even smartphones could be damaged, potentially rendering the photos and videos unusable and, of course, damaging their equipment. However, the purchase of specialized equipment can cost hundreds of dollars, if not more, and since the use of such equipment is practically restricted to rare or limited contexts, it may not be practical or feasible for many. Even if the upfront costs are not prohibitive, the specialized equipment is only beneficial to the user or owner if they remember to use it. That is, the owner or user must use some forethought to find the equipment and all necessary accessories from their storage locations, verify that the equipment is charged and works properly, and even maintain possession of such equipment before actually using it. Thus, many consumers seek opportunities to rent specialized equipment as needed.

Traditionally, it has been possible to rent specialized equipment, such as the exemplary action cameras referenced above, from vendors in physical brick and mortar stores. Brick and mortar stores are obviously limited by their business hours and physical location, or proximity to the user. Another approach includes renting the equipment from an online retailer and having the equipment shipped to the user. However, as this approach requires significant planning to get the equipment delivered on-time marked by uncertainty that the equipment will work. Even if all goes well, the consumer will have to go through a prolonged returned process that includes trusting a third-party servicer to not lose or damage the equipment before it is returned to its supplier.

In general, rental kiosks purport to solve the problem of high overhead associated with brick and mortar stores and the uncertainty of remote rental schemes. Some examples of such kiosks include U.S. Pat. No. 7,234,609 to DeLazzer, proposing the rental of items, such as DVDs, and traditional vending machines, such as U.S. Pat. No. 4,991,740 to Levasseur. These have been proposed as convenient alternates to the aforementioned approaches, but remain deficient. None of these proposals provide an integrated rental and sales system, method, and apparatus for specialized equipment. For example, one proposal, U.S. Pat. No. 10,157,376 to Aloe, is for a kiosk where a user may either rent or purchase a battery pack from the same kiosk. This proposal does not teach, nor suggest, the simultaneous purchase and sale of the battery pack. Instead, the rental and sale are two separate transactions, both targeted at the same product, a battery pack.

Another proposal, U.S. Pat. No. 6,644,455 to Ichikawa, teaches the use of a locker to rent cameras for use within a predetermined area. A warning transmitter is provided to alert the user if a rented camera is positioned outside of the predetermined area. Of course, limiting use to a predetermined area is largely inconveniently restrictive. Namely, such restriction prevents use of the camera for activities at remote locations. For example, a user may be prevented from using a camera rented under such disclosure on hikes, tours, snorkeling, parasailing, or other excursions easily accessible but remote from the locker location. As a result, a renter may be required to forego such camera, or other specialized equipment, at each excursion location, or rely on the possibility that each excursion location be equipped with a desirably outfitted locker. In addition to these disadvantages, this proposal limits user or renter access to any images they captured on the camera. Under the disclosure, captured images are transferred to a rental kiosk, where they are uploaded, and the consumer may select which of the images they want to purchase. The consumer does not possess the original images taken, either as a film negative or in digital form, which unfortunately prevents quality reproduction of the purchased images, especially as the quality of the printed image inevitably deteriorates with time. Further, the consumer is often forced to limit the images they want to print, either increasing the cost or limiting the memories.

Although rental kiosks and vending machines exist, none in existence provide for an integrated sale and rental machine configured to customize a rental and purchase transaction to the needs of the user, including the ability to rent and return the products at the user's convenience, without compromising the integrity of the transaction.

### SUMMARY

The present disclosure is directed to a method and machine for the integrated sale and rental of products. The machine may comprise a storage means, a user interface, a delivery means, a receiving means, and a communication means. The storage means may house at least one rental product and at least one non-rental product. Responsive to receiving an input via the user interface, the machine may carry out a method for conducting the sale and rental of at least one product.

For purposes of summarizing, certain aspects, advantages, and novel features have been described. It is to be understood that not all such advantages may be achieved in accordance with any one particular embodiment. Thus, the disclosed subject matter may be embodied or carried out in a manner that achieves or optimizes one advantage or group of advantages without achieving all advantages as may be taught or suggested.

In accordance with one embodiment, the storage means may be operative to store the at least one rental product and the at least one non-rental product. The at least one rental product may be stored in at least one container and the at least one non-rental product may be housed in at least one repository. In some embodiments, each of the at least one rental product may be housed in an individual of the at least one container. However, in another embodiment, multiple of the at least one rental product may be housed in the same of the at least one container. In such an embodiment, the at least one rental product may be the same rental product, however, in another embodiment, the multiple of the at least one rental product may be different rental products.

In one exemplary embodiment, the at least one rental product may be specialized equipment including, for example, an action camera. It is contemplated that the at least one non-rental product may be complementary to the at least one rental product. For example, when the at least one rental product is the action camera, the at least one non-rental product may be an SD card. However, a person of ordinary skill will appreciate that the aforementioned products are provided as examples only, and any products may be utilized.

The user interface may be any means operative to receive a response from a user. In one embodiment, the user interface may be a graphical user interface capable of receiving the input. The input may, for example, be a response to a display generated by the system on the graphical user interface. In other embodiments, the user interface may be a tangible user interface, multimedia user interface, or any other user interface recognized in the art.

The communication means may comprise a processor operative to carry out the method for conducting the sale and rental of the at least one product in response to receiving a transaction request at the user interface. The method may comprise the steps of receiving the transaction request, customizing a transaction, authenticating the user's identity, calculating a fee, receiving a payment, and delivering through the delivery means the at least one rental product and at least one non-rental product. In some embodiments, the transaction request may comprise receiving a response to a prompt displayed on the user interface. The transaction request may, in one embodiment, be a clickable element.

In response to receiving the transaction request, the user interface may display at least one rental option and at least one customization option. In one embodiment, the at least one rental option may display different rental packages. For example, the different rental packages may comprise different lengths of time, different rental products, or any other options known in the art.

In one embodiment, the transaction may comprise a selected at least one rental option and at least one customization option. The at least one customization option may, for example, be an additional of the at least one rental or non-rental product. In another example, the customization option may be an add-on, such as an insurance policy or accessory.

In some embodiments, the at least one rental option and the at least one customization option may be displayed simultaneously on the user interface. However, in another embodiment, the at least one customization option may be displayed after receiving a response to the at least one rental option. It is contemplated that in such an embodiment the at least one customization option may be specific to the at least one rental option. A selected at least one customization option may be operative to customize the transaction. However, if none of the at least one customization option is selected, the transaction may comprise the selected at least one rental option.

The next step may be to authenticate the user's identity; however, a person of ordinary skill will appreciate that the step of authenticating the user's identity may be conducted at any point throughout the method. In one embodiment, the step of authenticating may comprise receiving, on the user interface, a user's identifying information, transmitting an authentication request to a secondary device, and receiving a response to the authentication request.

It is contemplated that the user's identifying information may be any information operative to identify the user. For example, the user's identifying information may comprise a phone number, e-mail address, name, or reservation code. In some embodiments, the user's identifying information may be any identifying information capable of verification by a third-party source. For example, the user's identifying information may be a room key, payment card, state or federal identification cards, or any other information capable of identifying the user.

In some embodiments, the user's identifying information may be used to subsequently identify the transaction. For example, it may be used to facilitate a return or to communicate about the transaction.

In response to receiving the user's identifying information, the communication means may communicate the user's identifying information with at least one secondary device. It is contemplated that this may be operative to authenticate the user. For example, when the user's identifying information is their phone number or e-mail address, the communication means may be operative to transmit an authentication request to the inputted phone number or e-mail address. In another example, when the user's identifying information is the payment card, the communication means may transmit the authentication request to a financial institution.

In some embodiments, the authentication request may be an alphanumeric code transmitted to the at least one secondary device. The alphanumeric code may be inputted on the user interface and may be operative to authenticate the user. In another embodiment, an electronic invitation, such as a QR-code or link, may be sent to the user. Following the communication means receiving a response to the electronic invitation, either through the at least one secondary device or the user interface, the user may be authenticated. The aforementioned embodiments are provided as non-limiting examples for authenticating the user and any form of authentication may be utilized.

In one embodiment, the communication means may further comprise a memory. The memory may be operative to retain information received on the at user interface. The memory may be further operative to store information relating to components of the machine. For example, the memory may be operative to store information such as contents in the storage means.

The method may further comprise a step of calculating a fee. The fee may be calculated based on the selected at least one rental option and the at least one customization option. Thus, the fee may be customized to each transaction and may vary depending on what was selected.

It is contemplated the fee may further comprise a deposit. The deposit may be a pre-determined amount correlated with the at least one rental product.

In some embodiments, the step of calculating the fee may occur following authenticating the user. However, in another embodiment, calculating the fee may occur prior to authenticating the user. In one embodiment, the fee may be calculated simultaneously with the customization of the transaction.

Following the calculation of the fee, a payment may be received. In some embodiments, the payment may be received at the user interface. In some embodiments, the payment may be received as an input on the graphical user interface. However, in other embodiments, the user interface may comprise a means for receiving payment. The means for receiving payment may, for example, be a card reader, NFC reader, RFID read, bill reader, or any other means for receiving payment that may be contemplated. In some embodiments, the machine may comprise multiple of the means for receiving payment.

The payment may be any payment means known in the art, including, and without limitation, payment card, cash, or a charge to a pre-existing bill, such as a room or phone bill.

It is contemplated that, in some embodiment, the payment may not process until after the at least one rental product is returned. However, in another embodiment, at least some of the payment may process upon receiving the payment means.

Next, the at least one rental product and the at least one non-rental product may be delivered through the delivery means. In some embodiments, the delivery means may be separate delivery means for the rental and non-rental products. However, in another embodiment, the at least one delivery means may be the same for the at least one rental product and the at least one non-rental product.

In one embodiment, the delivery means for the at least one rental product may be a covering on the at least one container. The covering may, without limitation, be a lid, door, or any other covering. It is contemplated that the covering may comprise a latch capable of locking and unlocking depending on a signal transmitted by a processor. Thus, the method may further comprise a step of selectively transmitting the signal to the latch to unlock. It is contemplated that the signal may be sent in order to carry out the delivery step.

In a further embodiment, the delivery means for the at least one non-rental product may comprise a slot, a spiral, a pusher, an elevator, or any other delivery means as needed or desired. In some embodiments, the delivery means for the at least one non-rental product may comprise a combination of the aforementioned examples. It is contemplated that the delivery means for the at least one non-rental product may be operative to move the at least one non-rental product from the at least one repository to a location for delivery. The location for delivery may be any location in which the user is capable of accessing the at least one non-rental product. For example, and without limitation, the location for delivery may be the slot, a drawer, the at least one container, or any other locations that may be contemplated.

The machine may be further operative to carry out a method for the return of the at least one non-rental product. In some embodiments, the method for the return of the at least one non-rental product may comprise the steps of receiving a return request, receiving the user's identifying information, verifying that the user's identifying information corresponds to the user's identifying information received during the rental transaction, displaying at least one transaction associated with the user, receiving a confirmation of the at least one rental product being returned, receiving a quality condition of the at least one rental product, receiving the at least one rental product, calculating a refund, and transmitting the refund to the user.

The step of receiving the user's identifying information may be performed at the user interface. It is contemplated that the user's identifying information may be the same user's identifying information as received during the rental process.

However, in another embodiment, the user's identifying information may be different from the user's identifying information received during the rental process. In some such embodiments, the user may have a user account that comprises a plurality of the user's identifying information. It is contemplated that in such an embodiment, the user's identity may be verified even if the received user's identifying information is not identical to the identifying information received during the rental transaction. However, it is contemplated that the received user's identifying information must match at least one of the plurality of the user's identifying information. It is contemplated that the user may be further authenticated by any of the means previously discussed. For example, the alphanumeric code, QR code, or link.

In response to authenticating the user, at least one transaction associated with the user may be displayed. A selection of one at the at least one transaction displayed may be received confirming the displayed transaction comprises the at least one rental product being returned.

The quality condition of the at least one rental product may be received. In some embodiments, the quality condition may be a self-reported quality condition of the rental product. Thus, the user may report any damage or loss to the at least one rental product. In another embodiment, the machine may comprise a means to determine the quality condition of the at least one rental product. In such an embodiment, the step of receiving the at least one rental product may precede the step of receiving the quality condition.

If the quality condition of the at least one rental product is below a predetermined quality threshold, the communication means may transmit an inspection request to an administrative device. The at least one rental product may be removed from available rental products pending fulfillment of the inspection request.

The at least one rental product may be received at the receiving means of the machine. In some embodiments, the receiving means may be the same as the delivery means. Thus, in one embodiment, the receiving means may be the covering on the at least one container. However, in another embodiment, the receiving means may be distinct from the delivery means. In one embodiment, the receiving means may comprise a separate receiving means for the at least one rental product that is below the predetermined quality threshold.

In one embodiment, the refund may be equal to a deposit amount received as a condition for renting any products. It is contemplated that when the at least one rental product is received by the system below the predetermined quality threshold, the refund may be calculated following the fulfillment of the inspection request. It is contemplated that in such scenarios, the refund may be less than the deposit amount. Thus, the refund may depend on the quality condition of the at least one rental product and may be unique for each transaction.

Several advantages of one or more aspects of the method and machine for the integrated sale and rental of products are that they:
a.) customize each transaction according to user specification;
b.) enable the rental and return of products at the user's convenience; and
c.) preserve the user's privacy by maintaining ownership and/or possession of potentially identifying content with the user.

Thus, it is an object of the invention to increase the accessibility of specialized equipment.

It is another object of this invention to integrate the sale and rental of complementary products.

It is yet a further object of this method and machine to preserve otherwise ephemeral experiences, by simultaneously renting specialty equipment such as action cameras as needed and allowing the user to retain ownership of any images or other data captured on the specialty equipment following their return.

One or more of the above-disclosed embodiments, in addition to certain alternatives, are provided in further detail below with reference to the attached figures. The disclosed subject matter is not, however, limited to any particular embodiment disclosed.

### BRIEF DESCRIPTION OF THE DRAWINGS

FIG. 1 is a blocked diagram of a networked environment in which an exemplary embodiment of a method for an integrated sale and rental of products is implemented.

FIG. 2 shows an exemplary blocked diagram of one embodiment of a machine for the integrated sale and rental of products.

FIGS. 3A-B are flowcharts depicting an exemplary embodiment of a method for conducting an integrated sale and rental of at least one product from the machine in FIG. 2.

FIGS. 4A-B are flowcharts depicting an exemplary embodiment of a method for conducting a return of at least one rental product from the machine illustrated in FIG. 2.

FIG. 5 shows an exemplary embodiment of a user interface for receiving a transaction request as discussed in FIGS. 3A and 4A.

FIG. 6 illustrates an exemplary embodiment of a user interface for customizing a transaction as discussed in FIG. 3A.

FIG. 7 shows an exemplary embodiment of a user interface of a refund calculation as discussed in FIG. 3B.

The disclosed embodiments may be better understood by referring to the figures in the attached drawings, as provided below. The attached figures are provided as non-limiting examples for providing an enabling description of the system, method, and apparatus claimed. Attention is called to the fact, however, that the appended drawings illustrate only typical embodiments of this invention and are therefore not to be considered as limiting of its scope. One skilled in the art will understand that the invention may be practiced without some of the details included in order to provide a thorough enabling description of such embodiments. Well-known structures and functions have not been shown or described in detail to avoid unnecessarily obscuring the description of the embodiments.

One embodiment of the invention is implemented as a program product for use with a computer system. The program(s) of the program product defines functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive) on which information is permanently stored; (ii) writable storage media (e.g., floppy disks within a diskette drive or hard-disk drive) on which alterable information is stored. Such computer-readable storage media, when carrying computer-readable instructions that direct the functions of the present invention, are embodiments of the present invention. Other media include communications media through which information is conveyed to a computer, such as through a computer or telephone network, including wireless communications networks. The latter embodiment specifically includes transmitting information to/from the Internet and other networks. Such communications media, when carrying computer-readable instructions that direct the functions of the present invention, are embodiments of the present invention. Broadly, computer-readable storage media and communications media may be referred to herein as computer-readable media.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus

The terms “couple,” “coupled,” “couples,” “coupling,” and the like should be broadly understood and refer to connecting two or more elements or signals, electrically, mechanically or otherwise. Two or more electrical elements may be electrically coupled, but not mechanically or otherwise coupled; two or more mechanical elements may be mechanically coupled, but not electrically or otherwise coupled; two or more electrical elements may be mechanically coupled, but not electrically or otherwise coupled. Coupling (whether mechanical, electrical, or otherwise) may be for any length of time, e.g., permanent or semi-permanent or only for an instant.

### DETAILED DESCRIPTION

Having summarized various aspects of the present disclosure, reference will now be made in detail to that which is illustrated in the drawings. While the disclosure will be described in connection with these drawings, there is no intent to limit it to the embodiment or embodiments disclosed herein. Rather, the intent is to cover all alternatives, modifications and equivalents included within the spirit and scope of the disclosure as defined by the appended claims.

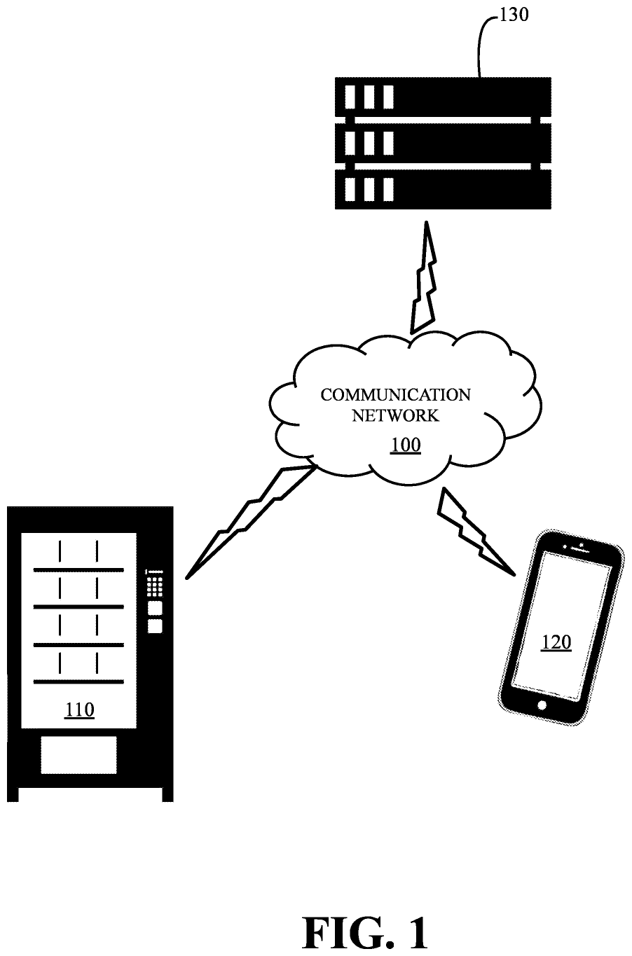

FIG. 1 illustrates, in a block diagram, an exemplary embodiment of a communication network 100 operative to carry out a method for an integrated sale and rental of at least one product. The communication network 100 may comprise a plurality of devices. By way of example, and not limitation, the plurality of devices may comprise a machine 110, at least one secondary device 120, and a server 130 communicatively coupled via the communication network 100. Each of the at least one secondary device 120 may be a computing device, such as a personal computer, tablet computer, laptop computer, smartphone or any other computing device known in the art. The machine 110, at least one secondary device 120, and the server 130 may be communicatively coupled using one or more various communication types such as, and without limitation, cellular and Wi-Fi communications.

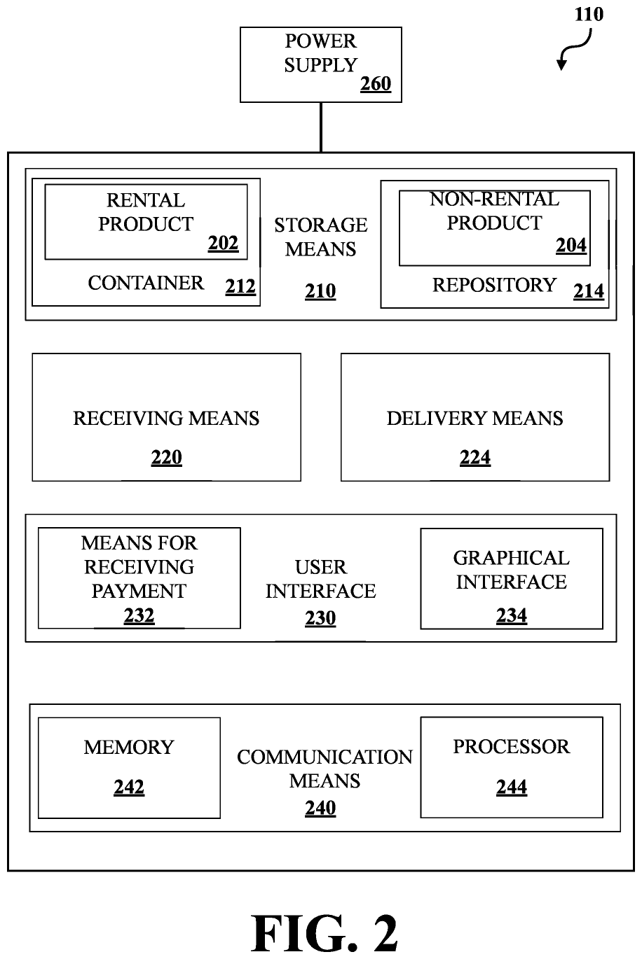

FIG. 2 illustrates an exemplary embodiment of the machine 110 shown in FIG. 1. As shown in FIG. 2, the machine 110 may comprise a plurality of modules. The plurality of modules may comprise a storage means 210, a receiving means 220, a delivery means 224, a user interface 230, and a communication means 242. A person of ordinary skill will appreciate that other modules may be used, and the provided plurality of modules comprises only one exemplary embodiment.

The storage means 210 may comprise at least one container 212 and at least one repository 214. The at least one container 212 may be configured to house at least one rental product 202 and the at least one repository 214 may be configured to house at least one non-rental product. In some embodiments, the at least one container 212 and the at least one repository 214 may be separate modules within the machine 110. However, in another embodiment, the at least one container 212 and the at least one repository 214 may comprise the same module within the machine. For example, the at least one container 212 may comprise the at least one repository 214.

The at least one rental product 202 may be specialized equipment. For example, and without limitation, the at least one rental product 202 may be an action camera, power tool, painting equipment, appliances, camping equipment, grilling equipment, or any other specialized equipment as needed or desired.

The at least one rental product 202 may further comprise at least one rental product accessory. Continuing with the action camera example, the at least one rental product accessory may, for example, and without limitation, comprise charging accessories, protective equipment, safety straps, external or detachable flashes, clamps, monopods, tripods, selfie-sticks, microphones, remotes, or any other accessory as needed or desired. A person of ordinary skill will appreciate the at least one rental product accessory may be an accessory complimentary to another of the at least one rental product, and the aforementioned embodiment is provided as a non-limiting example only.

The at least one container 212 may, in one embodiment, be a plurality of lockers. Each of the plurality of lockers may be configured to house one of the at least one rental product 202. The plurality of lockers may comprise lockers comprising multiple shapes and sizes, each operative to house one of the at least one rental product 202. It is contemplated that the multiple shapes and sizes may be selected to house a variety of types of the at least one rental product 202.

In one embodiment, each of the plurality of lockers may be the same size. It is contemplated that in such an embodiment, each of the at least one rental product 202 may be the same at least one rental product 202. It is contemplated that when each of the at least one rental product 202 is the same, any of the at least one rental product 202 may nevertheless comprise differences. For example, when the at least one rental product 202 is at least one action camera, the action cameras may be different brands, models, modes, designs, dimensions, quality, memory capacity, or any other differences.

In some embodiments, multiple of the at least one rental product 202 may be housed in one of the at least one container 220. More particularly, the at least one container 220 may house at least one rental product 202 and at least one rental product accessory. For example, in the embodiment comprising the action camera, the at least one container 220 may house the action camera and the charging accessory. However, in another embodiment the at least one rental product accessory may be housed in a separate at least one container 220 from the at least one rental product 202. In yet another embodiment, some of the at least one rental product accessory may be housed in the same at least one container 220 as one of the at least one rental product 202.

In some embodiments, the at least one container 212 may comprise at least one charging means or charging accessory. The at least one charging means may be operative to charge an electric at least one rental product 202. It is contemplated that in such an embodiment, a power supply 260 may be connected to the at least one container 212 and operative to power the at least one charging means.

The at least one non-rental product 204 may be any product known in the art. In an exemplary embodiment, the at least one non-rental product 204 may be complementary to the at least one rental product 202. For example, when the at least one rental product 202 is the action camera, the at least one non-rental product 204 may be an SD card or any other complimentary product. In other embodiments, the at least one non-rental product 204 may be any product complementary to the at least one rental product 202, including, for example, and without limitation, fuel, personal protective equipment, single-use cooking tools, nails and/or screws, or paint brushes.

The at least one repository 214 may be any means capable of storing the at least one non-rental product 204. For example, the at least one repository 214 may be at least one shelf, bin, compartment, drawer, hook, or any form of storage.

In one embodiment, the at least one repository 214 may comprise a plurality of the at least one non-rental product 204. In such an embodiment, the delivery means 224 may be operative to separate the plurality of the at least one non-rental product 204. Thus, the delivery means 224 may be operative to only deliver the number of the at least one non-rental product 204 requested.

In some embodiments, there may be a variety of the at least one non-rental product 204. Each of the variety of the at least one non-rental product 204 may be housed in one of the at least one repository 214 associated with the variety of the at least one non-rental product 204. In one embodiment, the delivery means 224 may be configured to selectively access the at least one repository 214. Thus, the delivery means 224 may be operative to deliver only a requested at least one non-rental product.

However, in another embodiment, each of the at least one repository 214 may comprise only one variety of the variety of the at least one non-rental product 204. It is contemplated that in such an embodiment, the delivery means 224 may be configured to selectively deliver a requested at least one non-rental product 204.

The delivery means 224 may be configured to differentiate between the variety of the at least one non-rental product 204 in one of the at least one repository 214. For example, the at least one non-rental product 204 may comprise a machine-readable identifier, such as a barcode, RFID tag, or any other machine-readable identifier that may be known in the art. The delivery means 224 may comprise a reader capable of reading the machine-readable identifier. In another embodiment, the delivery means 224 may comprise a camera operative to sort the at least one non-rental product 204 using image processing techniques. A person of ordinary skill in the art will appreciate that sorting using image processing is well known in the art and that any means may be utilized.

In some embodiments, the delivery means 224 may be the same delivery means 224 for the at least one rental product 202 and the at least one non-rental product 204. Thus, the delivery means 224 may be operative to access both the at least one container 212 and the at least one repository 214. However, in another embodiment, the delivery means 224 for the at least one rental product 202 may be distinct from the at least one non-rental product 204.

In one embodiment, the delivery means 224 may be a covering over each of the at least one container 212. The covering may, for example and without limitation, comprise a lid, door, or any other covering. The covering may be operative to cover at least some of an opening on the at least one container 212 and allow selective access. It is contemplated that the covering may comprise a locking means, such as a latch, that may be locked and unlocked to provide access to the at least one container 212. The locking means may be any locking means, such as the aforementioned latch, an actuator, a cam lock, or any other locking means known in the art. In some embodiments, the locking means may be an electrical locking means connected to the power supply 260 and the communication means 240. However, in another embodiment, that locking means may be a mechanical locking means and may require inputting a key or code to lock and unlock.

In another embodiment, the delivery means 224 may comprise an access point. The access point may be any of a slot, dispenser, drawer, pick-up box, or any other means for accessing the at least one product.

In some embodiments, the delivery means 224 may comprise a transit means capable of moving any of the at least one rental product 202 and the at least one non-rental product 204 from the storage means 210 to the delivery means 224. In one embodiment, wherein the storage means 210 is at least one shelf, the transmit means may comprise a product pusher. A person of ordinary skill in the art will appreciate that the product pusher may comprise any product pusher known in the art. For example, the product pusher may comprise a spiral, a gear, or any other product pusher as known in the art. The product pusher may be configured to cause any of the at least one rental product 202 and the at least one non-rental product 204 to move from the storage means 210 to the access point.

In another embodiment, the transmit means may comprise an elevator operative to move any of the at least one rental product 202 and the at least one non-rental product 204 from the storage means 210 to the access point.

In some embodiments, the receiving means 220 may comprise any components utilized by the delivery means 224. For example, and without limitation, when the delivery means 224 comprises at least one opening on the at least one container 212, the at least one opening may be the receiving means 220. In another embodiment, the receiving means 220 may be a receiving point, such as a box, slot, drawer, or any other point configured to receive.

In some embodiments, the receiving means 220 may comprise a product verification means operative to verify that the at least one rental product 204 received is the same at least one rental product 204 as was delivered to a particular use.

In one embodiment, the product verification means may be a scanner. It is contemplated that in such an embodiment, the at least one rental product 204 may comprise the identification means. The identification means may be operative to identify each of the at least one rental product 202 such as a graphical machine-readable medium, an RFID tag, an NFC identifier, or any other identification means as may be needed or desired. The graphical machine-readable medium may, for example, and without limitation, be a QR code, barcode, cryptogram, or any other graphical machine-readable medium. The scanner may be operative to read the identification means on the at least one rental product. It is contemplated that the scanner may be operative to read any of the identification means previously described.

In another embodiment, the product verification means may comprise a camera operative configured to identify the at least one non-rental product. The camera may be operative to receive optical input and transmit the optical input to a processor 244. The processor 244 may be operative to process the optical input to determine whether the at least one rental product 202 was received. In one such embodiment, the processor 244 may verify that the at least one rental product 202 is received when any object is present in the view of the camera. In another embodiment, the processor 244 may verify that the at least one rental product 202 is the same at least one rental product 202 that was rented. For example, when the at least one rental product 204 is the action camera, the product verification means may be able to identify whether the action camera is returned. Thus, returning a product that is not the action camera will not be verified.

In yet another embodiment, when the at least one rental product 202 is an electronic device, such as the action camera, the product verification means may be a plug-and-play interface, known to those of ordinary skill in the art, configured to engage with the electronic device. The plug-and-play interface may be operative to receive an identifier from the electronic device. For example, the identifier may be a serial number, name, or other identifier as contemplated in the art. The plug-and-play interface may be a USB or any other interface as known in the art. In some embodiments, the plug-and-play interface may be the charging means.

The user interface 230 may comprise a graphical user interface 234 and a means for receiving payment 232. The graphical user interface 234 may be any interface operative to receive an input. In one embodiment, the graphical user interface 234 may comprise a touchscreen interface.

In some embodiments, additional user interfaces may be utilized. For example, a keypad, an audio interface, or any other user interface as known in the art.

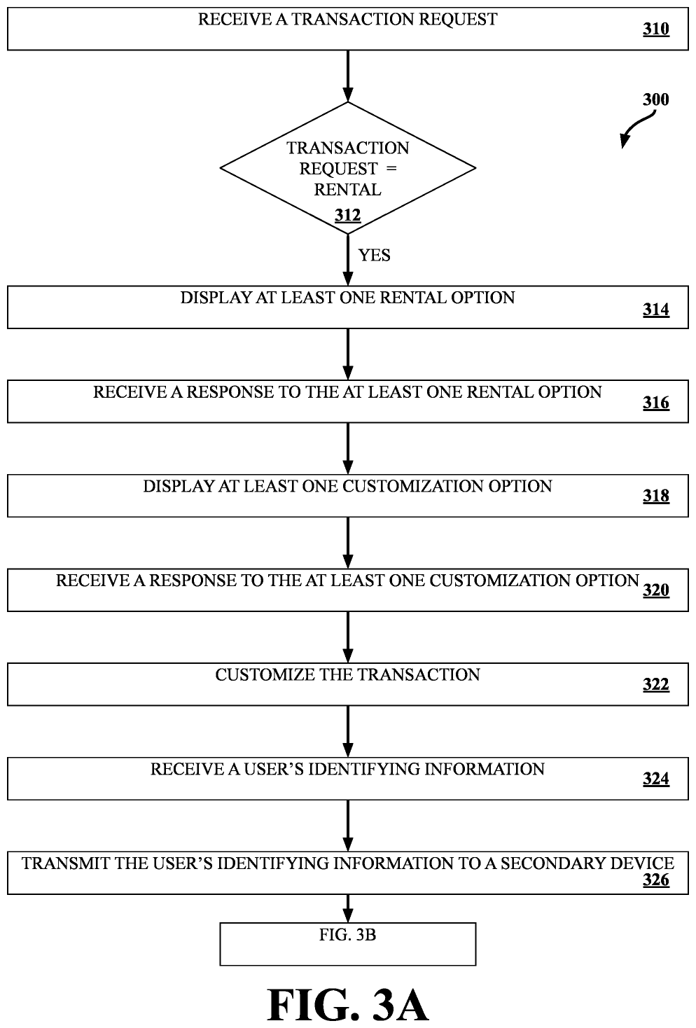

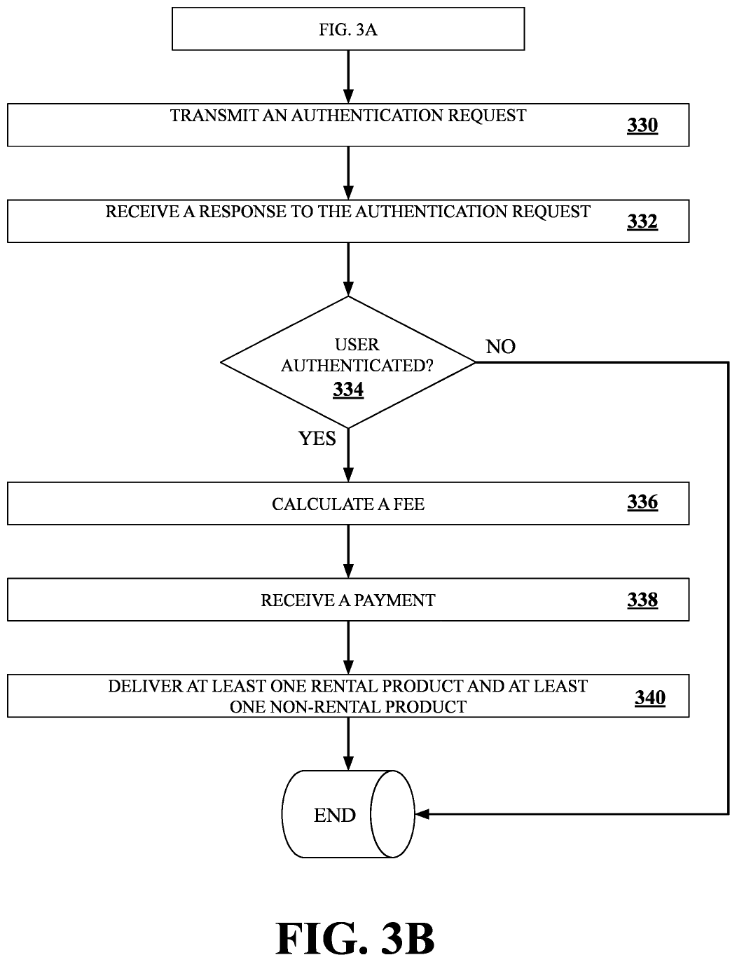

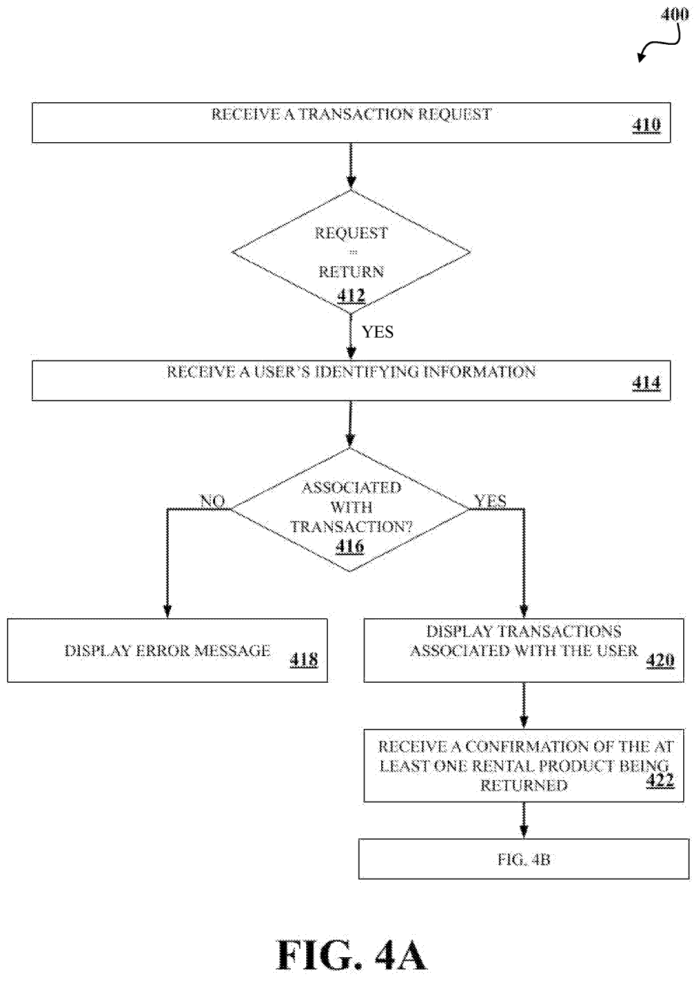

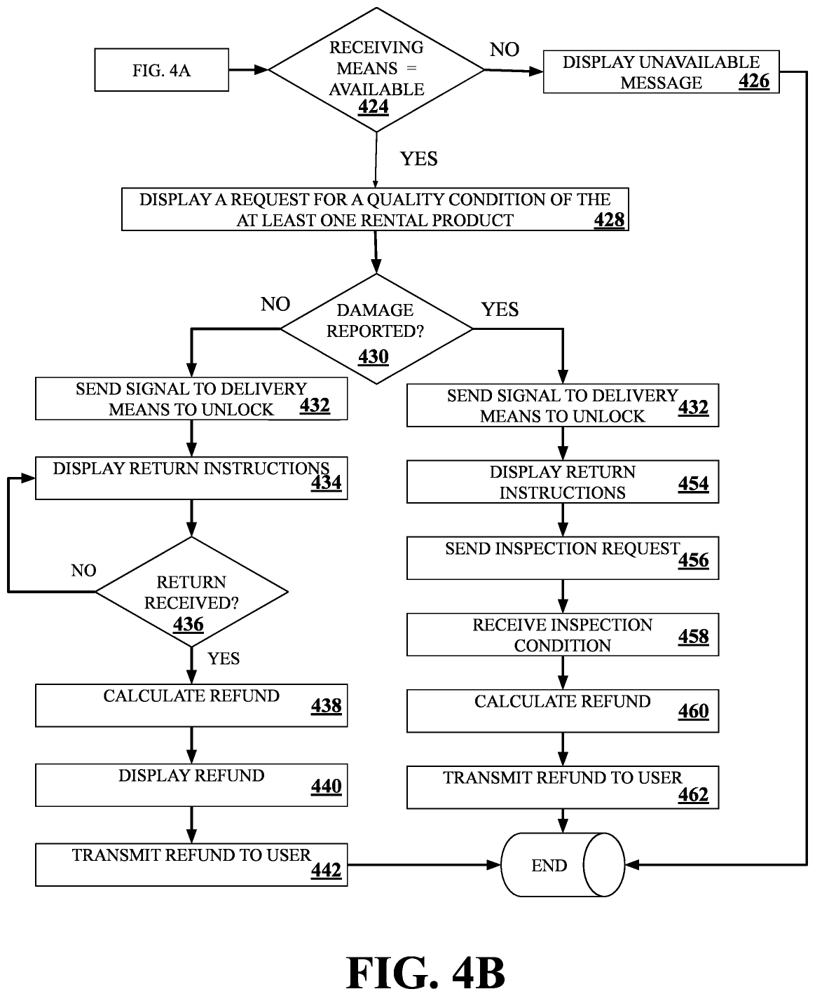

In one embodiment, the user interface 230 may be on the at least one secondary device 120 illustrated in FIG. 1. The at least one secondary device 120 may be operative to perform any steps of receiving and displaying as discussed in FIGS. 3-4. In such an embodiment, the at least one secondary device 120 may communicate with the machine 110 through the communication network 100.

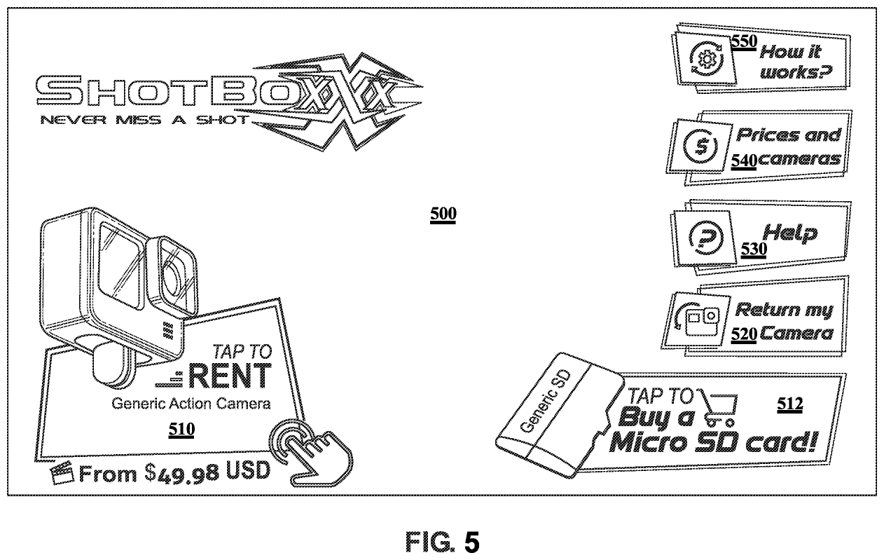

Certain exemplary examples of the graphical user interface 234 are discussed below with reference to FIGS. 5-7.

Returning to FIG. 2, the means for receiving payment 232 may be any means capable of receiving a payment. It is contemplated the payment may be received from any payments means, such as a payment card, cash, or a charge to a pre-existing bill, such as a charge to a hotel or cruise ship room. Thus, the means for receiving payment 232 may be operative to receive any of a large variety of payment means known to those of ordinary skill in the art. In one embodiment, the means for receiving payment 232 may be a card reader. However, in another embodiment the means for receiving payment 232 may comprise a bill reader. The aforementioned embodiments are provided for example only and the means for receiving payment 232 may be in any form known in the art. A person of ordinary skill in the art will appreciate that the machine 110 may comprise any number of the aforementioned means for receiving payment 232.

The machine 110 may further comprise the communication means 240. The communication means 240 may be operative to correspond with the communication network 100 illustrated in FIG. 1. The communication means 240 may be configured to transmit and receive communications from any of the plurality of devices 120 and 130 through the communication network 100. It is contemplated that the communication means 240 may be operative to carry out a method as described in FIGS. 3 and 4.

More particularly the communication means 240 of FIG. 2 may further comprise a processor 244 operative to carry out the methods as described in FIGS. 3 and 4. The processor 244 may be operative to couple any of the modules of the machine 110 to another module. For example, the processor 244 may be operative to transmit information received on the user interface 230 to the communication means 240. In response to transmitting the information to the communication means 240 the processor 244 may instruct an action on the storage means 210, receiving means 220, or delivery means 224. For example, the processor 244 may instruct the delivery means 224 to deliver the at least one rental product 202.

With continued reference to FIG. 2, the communication means 240 may comprise a memory 242. In some embodiments, the memory 242 may be operative to store information relating to the machine 110. For example, the memory 242 may store information such as contents in the storage means 210, information received at the user interface 230, and the methods as described in FIGS. 3 and 4.

In some embodiments, the memory 242 may be a cloud memory, stored on the server 130 illustrated in FIG. 1. In such an embodiment, the communication means 240 may be operative to access the memory 242 through the communication network 100. However, in another embodiment, the memory 242 may be stored on the machine 110 described in FIG. 2.

The machine 110 may further comprise the power supply 260. The power supply may be operative to provide power to any electrical components of the machine 110. Further, in some embodiments, the power supply 260 may be operative to provide power to the at least one charging means.

FIGS. 3A and B comprise a flowchart depicting an exemplary embodiment of a method 300 for conducting the sale and rental of at least one product such as may be performed by the machine 110 described in FIG. 2. In some embodiment, a system may carry out the method 300. A person of ordinary skill will recognize that the machine 110 and method 300 may define the aforementioned system. It is contemplated that the steps of receiving and displaying may be carried out using the user interface 230 discussed in FIG. 2.

As shown in FIG. 3A, the method may comprise the steps of receiving a transaction request 310, and if the transaction request is a rental request 312, displaying at least one rental option 314. The step of receiving the transaction request may be received on the graphical user interface 234, such as the exemplary interface displayed in FIG. 5 which will be discussed in more detail below.

For example, the displayed at least one rental option may display the at least one rental product housed within the at least one container. In some embodiments, where the machine comprises a plurality of types of the at least one rental product, the different types of rental products may be displayed.

The at least one rental option may comprise a selection of one of the at least one rental products. In some embodiments, the at least one rental option may comprise a variety of rental package options. Each of the at least one rental package options may comprise at least one rental product, a length of rental period, and at least one non-rental product. A person of ordinary skill will recognize that the rental package options may comprise any options that may be contemplated.

It is contemplated that only the at least one rental product currently housed in the at least one container may be displayed. However, in some embodiments, the at least one rental option may comprise at least one rental product not currently housed within the machine. In such an embodiment, the unavailable at least one rental product may be not available to rent. In some embodiments, the unavailable at least one rental product may list an estimated time of availability and may allow a hold to be placed on the unavailable at least one rental product.

In some embodiments, the response to the at least one rental option may be to decline the at least one rental option. In some embodiments, the method 300 for conducting the sale and rental of at least one product may be terminated when the response is to decline the at least one rental option. In another embodiment, the response to decline the at least one rental option may display at least one customization option 318.

Returning to the method of FIG. 3A, a response to the at least one rental option may be received 316. In the exemplary method shown, the response may be operative to identify a selected at least one rental option. The user interface 230 may display at least one customization option 318. The at least one customization option may, in some embodiments, comprise customization of a rental period, rental product, non-rental product, add-on, such as an insurance policy, or any other customization that may be contemplated. In some embodiments, the at least one customization option displayed may comprise the at least one rental option as displayed in the prior step (314).

In one, non-limiting, example, the selected at least one rental option may be for an action camera and the at least one customization option may be specific to the action camera. For example, the at least one customization option may be the length of the rental period, additional of the at least one non-rental products, and damage insurance. More particularly, the at least one customization option may allow the rental of the action camera for additional days and the purchase of additional SD cards. A person of ordinary skill will recognize that other customization options are contemplated and any customization option as needed or desired may be utilized.

The system may receive a response to the at least one customization option 322. Following receiving the response to the at least one customization option 322, the transaction may be customized 322.

A user's identifying information may be received 324 on the user interface 230. In one embodiment, the user's identifying information may be a user's contact information, such as a phone number or e-mail address. In such an embodiment, the secondary device may be an electronic device associated with the user.

In some embodiments, the user's identifying information may define a user account. The user's account may be operative to recognize the user at any machine 110. secondary device 120, and server 130 connected via the communication network 100 illustrated in FIG. 1.

In some embodiments, a code may be sent to the secondary device. In such an embodiment, the response received to the authentication request 332 may be the code sent to the secondary device. However, in another such embodiment, the response may be a confirmation that a code displayed on the machine 110 matches the code sent to the secondary device. In such an embodiment

In another embodiment, a machine-readable code may be sent to the secondary device. The machine-readable code may, for example, and without limitation, be a QR-code, barcode, or other scannable code as recognized in the art. In such an embodiment, the machine 110 may comprise a means for reading the machine-readable code, such as a barcode scanner. The response received in response to the authentication request 332 may be the reading of the machine-readable code at the machine 110. For example, it may be the scanning of the aforementioned QR code.

However, in another embodiment, a link may be transmitted to the secondary device. In response to receiving an interaction with the link on the secondary device, the response to the authentication request may be transmitted and received 332 by the machine 110.

In another embodiment, the user's identifying information may be transmitted to the server 130 shown in FIG. 1 and may be associated with a pre-existing account. In such an embodiment, the response received to the authentication request 332 may comprise the pre-existing account and a personal identification number or code being received by the machine 110.

While in the exemplary method shown in FIG. 3A the step of receiving a user's identifying information 324 follows customizing the transaction 322, this is provided as a non-limiting example only. The step of receiving the user's identifying information 324 may be carried out at any point during the method. For example, in some embodiments, receiving the user's identifying information may be the first step, however, in another example, receiving the user's identity may occur alongside any other step.

Following receiving the response from the previous step (332), the user may be authenticated 334. It is contemplated that the user may not be authenticated when the response received in the previous step (332) does not match the authenticating information.

A fee may be calculated 336 according to the transaction customized in step 322. The fee may comprise a base fee determined by the at least one rental option, at least one customization fee determined by the at least one customization option, a deposit for the at least one rental product, and associated taxes and fees as may be required. For example, and without limitation, each of the at least one customization fees may be associated with one of the at least one customization options. Thus, the fee may be unique to the customized transaction.

In some embodiments, the fee may be displayed and the transaction may be further customized. The further customization may cause the fee to be recalculated and an updated fee may be displayed.

A payment may be received 338 on the user interface 230. As discussed in FIG. 2, the machine 110 may comprise the means for receiving payment 232. However, in some embodiments, the payment may be received on the at least one secondary device. In yet another embodiment, a stored payment means may be associated with the pre-existing user account.

It is contemplated that the payment may place a hold, known to those of skill in the art, of an amount equal to the fee. However, in some embodiments, the payment may immediately withdrawal an amount equal to the fee minus the deposit. In another embodiment, the payment may immediately withdraw the entire fee from the payment means.

Upon receiving payment, the at least one rental product and at least one non-rental product may be delivered 340. The delivery may occur using the delivery means 224 and, in any manner, as was discussed in FIG. 2.

FIGS. 4A and B are a method for conducting the return of at least one rental product that may performed by the machine 110 illustrated in FIG. 2. Starting with FIG. 4A, a transaction request may be received 410. In some embodiments, the transaction request may be received at the same user interface as the transaction request received 310 in FIG. 3A.

The user's identifying information may be received 414. It is contemplated that this may be the user's identifying information received in step 324 in FIG. 3A. However, the user's identifying information may be any identifying information. For example, the user's identifying information may be the payment means received 338 in FIG. 3A.

In one embodiment, another form of identifying information may be received. For example, the identifying information may be a transaction number, a rental code, the payment means, or an identifier on the at least one non-rental product.

If the user's identifying information is not associated with a transaction 416, an error message may be displayed 418. The displayed error message 418 may, in some embodiments, request further identifying information. In another embodiment, the error message may cause the method to terminate.

In instances where the received user's identifying information is associated with a transaction 416, all transactions associated with the user may be displayed 418. In some embodiments, the displayed transactions may comprise all outstanding transaction. In another embodiment, the displayed transactions may comprise all transactions associated, outstanding or completed.

A confirmation of the at least one rental product being returned 422 may be received. The confirmation may comprise a selection from the displayed transaction. More particularly, the confirmation may comprise a selection from the outstanding displayed transactions.

Responsive to confirming the at least one rental product being returned, it may be determined whether the machine can receive the at least one rental product. More particularly, whether there is a receiving means available to receive the at least one rental product. If no receiving means is available to receive the at least one rental product, an unavailable message may be displayed 426. In some embodiments, the unavailable message may comprise other return options. The other return options may comprise other machines in an area, an estimated time when the receiving means may be available, or other information as may be desired.

When the receiving means is available 424 a request for a quality condition of the at least one rental product may be displayed 428. The quality condition may be the quality of the at least one rental product when returned. For example, the quality condition may reflect physical damage on the at least one rental product, including, without limitation, scratches and dents. The quality condition may further reflect internal damage, such as water damage. In some embodiments, the quality condition may further comprise the loss of the at least one rental product.

In some instances, a preliminary quality condition may be associated with the at least one rental product. In one embodiment the preliminary quality condition may be received during the method 300 for the sale and rental of at least one product illustrated in FIGS. 3A and B. In another embodiment, the preliminary quality condition may be the quality condition of the at least one rental product received in a prior transaction.

If no damage is reported 430, a signal may be sent to the delivery means 432. The signal may instruct the delivery means to receive the at least one rental product. The delivery means may be operative to receive the at least one rental product in any manner as described above or as may be contemplated in the art.

A set of return instructions may be displayed 434. The set of return instructions may comprise information regarding how to return the at least one rental product in the delivery means. In some embodiments, when multiple of the at least one rental product is being returned, the return instructions may comprise separate instructions for each of the at least one rental product.

For example, when the at least one rental product is the action camera, the return instructions may comprise instructions on connecting the action camera with the charging means, removing the SD card, or any other instructions as may be contemplated.

The machine 110 may confirm that the at least one rental product is received 436. In some embodiments, the confirmation may be received on the user interface. In another embodiment, the confirmation may be received from the receiving means 222.

A refund may be calculated 438 following receiving the at least one rental product. In some embodiments, the refund may comprise the deposit received in step 338 of FIG. 3B. However, in another embodiment, the refund may comprise less than all the deposit. For example, when the at least one rental product is returned outside the rental period, an amount may be deducted from the deposit. The refund may be displayed 440 and may comprise an itemized list of the customized transaction. The refund may be transmitted to the user 442. In some embodiments, the refund may be transmitted to the payment means associated with the transaction. In another embodiment, the payment may fully process and the refund may be deducted from the fee prior to processing.

If damage is reported 430, a signal may be sent to the delivery means 432 and a set of damage return instructions may be displayed 454. The damage return instructions may be dependent on the quality condition of the at least one rental product. In some embodiments, the damage return instructions may comprise a prompt to more information relating to the quality condition of the at least one rental product. In another embodiment, the damage return instructions may comprise displaying a set of return instructions displayed in step 434.

An inspection request may be transmitted to an administrative device. In some embodiments, the administrative device may be the server 130 discussed in FIG. 1. In another embodiment, the administrative device may be the secondary device 120.

In some embodiments, the method 400 for the return of at least one rental product may comprise an intermediary step of verifying the return is received. It is contemplated that any of the embodiments described for step 436 may be utilized.

Continuing with FIG. 4B, an inspection condition may be received 458. The inspection condition may be received from the administrative device. The inspection condition may comprise a report of the damage on the at least one rental product.

In some embodiments, the inspection condition may be operative to remove the at least one rental product from the machine.

FIG. 5 illustrates an exemplary, non-limiting embodiment of a user interface 500 for receiving a transaction request. The interface may display a prompt user to select a transaction. The prompt may be displayed as a clickable button, however, one skilled in the art will recognize that user responses to prompts may be received through various clickable elements on the interface.

Certain exemplary transaction prompts are illustrated in FIG. 5, including, without limitation, a rental transaction 510 (here, TAP TO RENT GENERIC ACTION CAMERA), a sale transaction 512 (here, TAP TO BUY A MICRO SD CARD!), and a return transaction 520 (here, RETURN MY CAMERA). The user interface may further prompt the user to learn more about the system. For example, the prompt may comprise a tutorial 550 (here, HOW IT WORKS?), a catalog 540 (here, PRICES AND CAMERAS), and assistance 530 (here, HELP). The aforementioned prompts are provided as non-limiting examples only and any prompt as needed or desired may be utilized. In response to a selection of one of the prompts, a new interface, determined by the prompt selected, may be displayed.

When the rental transaction 510 prompt is selected, the method 300 for the sale and rental of at least one product described in FIGS. 3A and B may be performed. Thus, the new interface may display the at least one rental option 314 as discussed in FIG. 3A. It is contemplated that any subsequent interfaces may be operative to perform the method 300 described in FIGS. 3A and B.

When the sale transaction 512 prompt is selected, the new interface may comprise a list of the at least one non-rental products. The list of the at least one rental product may display a type of the at least one non-rental product and a cost for each of the at least one non-rental product. A selection of at least one of the at least one non-rental products may be received and payment may be received. It is contemplated that the sale transaction may be carried out in any manner as known in the art, including without limitation in the manner as described in steps 336, 338, and 340 in FIG. 3B.

Upon receiving the selection of the return transaction 520 prompt, the system may be operative to perform the method 400 for the of at least one rental product shown in FIGS. 4A and B. Thus, the new interface may display a prompt to receive the user's identifying information. The user's identifying information may be received 414 through the selection of at least one clickable element, text, checkbox, or any other input known in the art. It is contemplated that subsequent displayed interfaces may be capable of receiving and displaying the method 400 as described in FIGS. 4A and B.

The selection of the tutorial 550 may display information relating to a purpose of the machine 110. For example, the tutorial 550 may describe the method 300 for the sale and rental of at least one product and the method 400 for the return of at least one rental product. However, the tutorial 550 may display instructions on how to operate any of the at least one product. A person of ordinary skill will appreciate that the aforementioned embodiments are for example only and any tutorial as needed or desired may be displayed.

The selection of the catalog 540 prompt may display a list of the at least one rental products, the list of the at least one non-rental products, and prices for each. Further, the catalog 540 may display a list of the at least one rental option and the at least one customization option, as discussed in step 314 of FIG. 3A, and a price for each. The price may comprise a rental rate, a base rate, a purchase rate, and any other rates as desired.

In some embodiments, the catalog 540 may display only the at least one rental product and the at least one non-rental product currently available. For example, only that at least one rental product and at least one non-rental product in the machine when the catalog 540 prompt is selected may be displayed. In another embodiment, the catalog 540 may display the at least one rental product and at least one non-rental product, regardless of their availability status.

Responsive to receiving the selection of the assistance 430 prompt, a help interface may be displayed. In some embodiment, the help interface may comprise a list of frequently asked questions and their answers. In another embodiment, the help interface may comprise contact information, such as a phone number, e-mail address, or website address. In yet a further embodiment, the help interface may be operative to facilitate communication with the at least one secondary device. It is contemplated that the at least one secondary device may be the administrative device. A person of ordinary skill will appreciate that the help interface may take any form as needed or desired.

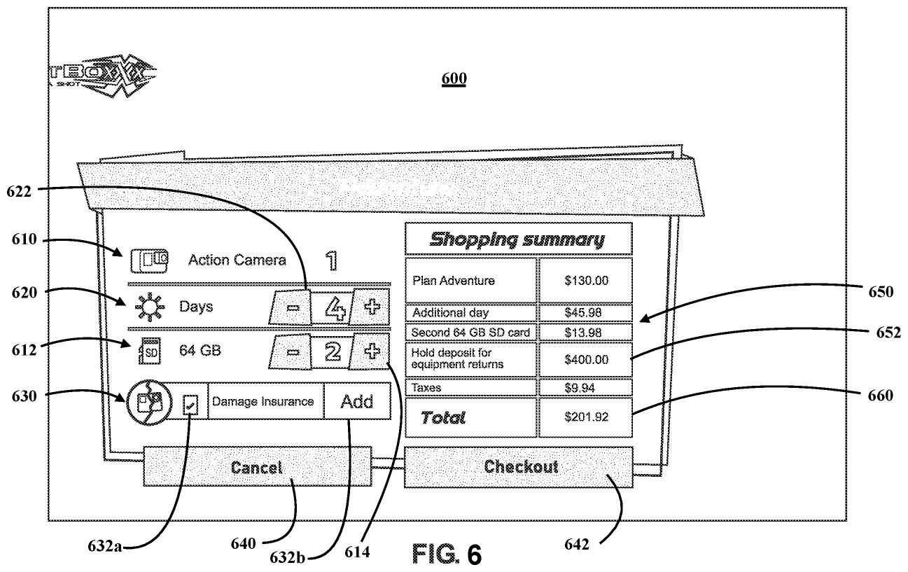

FIG. 6 illustrates one exemplary embodiment of an interface 600 for customizing the rental transaction. It is contemplated that the interface 600 for customizing the rental transaction may be the displayed at least one customization option 318 from FIG. 3A.

The interface 600 may, for example, display the at least one rental option selected in step 316 of FIG. 3A. It is contemplated that the selected at least one rental option may be displayed with a selected at least one rental product 610 (here, ACTION CAMERA), a selected at least one non-rental product 612 (here, 64 GB), and a rental period 620 (here, DAYS) listed separately. The interface may further display customization options relating to the selected at least one rental option. For example, the displayed customization options may be operative to customize a length 622 of the rental period, quantity 614 of the selected at least one rental product, and a rental policy 630. As shown, the length 622 of the rental period may be customized using clickable elements that add or remove time from the rental period. However, any form of customizing the length 622 of the rental period may be utilized, including, a metric slider, drop-down list, or numerical input, are contemplated.

It is contemplated that the quantity 614 of the selected at least one rental product may be customized. As shown, the quantity 614 of the selected at least one rental product may be customized in the same manner as described for the length 622 of the rental period. However, in another embodiment, the quantity 614 of the selected at least one rental product may be customized in any manner, including a manner different than the length 622 of the rental period.

The interface 600 may further display an add-on 630 (here, DAMAGE INSURANCE). It is contemplated that the add-on 630 may be specific to the selected rental option. For example, in the embodiment shown in FIG. 6, the add-on 630 is an insurance policy. In another embodiment, the add-on 630 may be an additional at least one rental product, an additional at least one non-rental product, a loss protection policy, or any other add-on as may be contemplated.

The add-on 630 may be selected via a clickable element 632a and b. The clickable element 632a and b may be a clickable button 632b, a checkbox 632a, or any other clickable element as known or desired.

Certain exemplary customization options are discussed in FIG. 3A and may be displayed here, however, the interface 600 may comprise any customization option as needed or desired.

The interface 600 may further display a transaction summary 650. In the exemplary embodiment illustrated, the transaction summary 650 may comprise a preliminary fee calculation. In some embodiments, the preliminary fee 660 calculation may be equal to the fee calculated in step 336 of FIG. 3B. However, the preliminary fee 660 may be different from the fee calculated in step 336 of FIG. 3B.

The transaction summary 650 may display a cost associated with each of the selected at least one rental product 610, length of rental period 620, selected at least one non-rental product 612, and the add-on 630. Additionally, the transaction summary 650 may comprise the deposit 652 amount for the selected at least one rental product 610.

It is contemplated that the preliminary fee may change in response to a change in the at least one customization options.

The interface 600 may further comprise prompts to cancel 640 the transaction or continue 642 (here, CHECKOUT). It is contemplated that in response to a selection of the continue 642 prompt, a prompt operative to carry out the step of receiving the user's identifying information 324 from the method 300 described in FIG. 3A may be displayed.

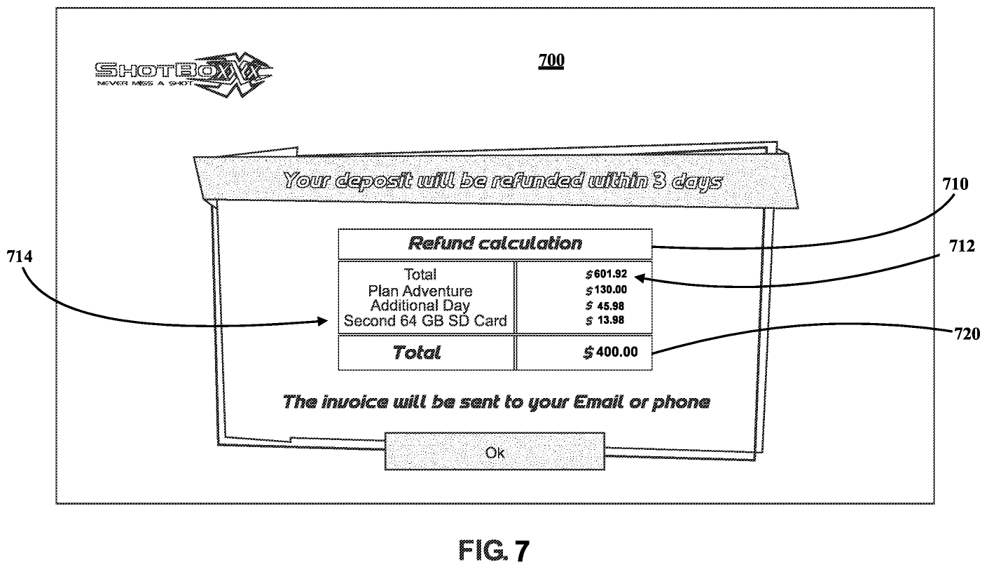

FIG. 7 illustrates an exemplary, non-limiting embodiment of a user interface 700 for a refund calculation. It is contemplated that this interface 700 may be displayed at step 440 of FIG. 4B. As shown in FIG. 7, a refund 720 (here, TOTAL REFUND) may be displayed. A manner for calculating the refund 710 may further be displayed. In the embodiment shown in FIG. 7, the manner for calculating the refund 710 the fee 712, calculated in step 336 of FIG. 3B and at least one charge 714 may be displayed. The refund 710 may be equal to the fee 712 minus each of the at least one charge 714. It is contemplated that the at least one charge 714 may be an itemized list of each the rental option price, the customization price, and any other charges.

In some embodiments, the refund 720 may be equal to the deposit 652 discussed in FIG. 6. However, in another embodiment the refund 720 may be less than the deposit 652. For example, the refund 720 may be less than the deposit 652 when damage was reported in step 430 of FIG. 4B or the at least one rental product was returned outside of the rental period. It is contemplated that the at least one charge 714 may list any amount of the deposit that was not returned and a reason.

Any of the methods for calculating the refund 438 as discussed in reference to FIG. 4B may be displayed on the interface 700 of FIG. 7.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

### CONCLUSIONS, RAMIFICATIONS, AND SCOPE

While certain embodiments of the invention have been illustrated and described, various modifications are contemplated and can be made without departing from the spirit and scope of the invention. For example, the machine may be utilized in the absence of payment, or for alternative payment such as vouchers or digital codes. Accordingly, it is intended that the invention not be limited, except as by the appended claim(s).

The teachings disclosed herein may be applied to other systems, and may not necessarily be limited to any described herein. The elements and acts of the various embodiments described above can be combined to provide further embodiments. All of the above patents and applications and other references, including any that may be listed in accompanying filing papers, are incorporated herein by reference. Aspects of the invention can be modified, if necessary, to employ the systems, functions and concepts of the various references described above to provide yet further embodiments of the invention.

Particular terminology used when describing certain features or aspects of the invention should not be taken to imply that the terminology is being refined herein to be restricted to any specific characteristics, features, or aspects of the integrated sale and rental of specialized equipment with which that terminology is associated. In general, the terms used in the following claims should not be constructed to limit the integrated sale and rental of specialized equipment to the specific embodiments disclosed in the specification unless the above description section explicitly define such terms. Accordingly, the actual scope encompasses not only the disclosed embodiments, but also all equivalent ways of practicing or implementing the disclosed self-service vending machine, system, and method. The above description of embodiments of the integrated sale and rental of specialized equipment is not intended to be exhaustive or limited to the precise form disclosed above or to a particular field of usage.

While specific embodiments of, and examples for, the self-service vending machine, system, and method are described above for illustrative purposes, various equivalent modifications are possible for which those skilled in the relevant art will recognize.

While certain aspects of the method, system, and apparatus disclosed are presented below in particular claim forms, various aspects of the same are contemplated in any number of claim forms. Thus, the inventor reserves the right to add additional claims after filing the application to pursue such additional claim forms for other aspects of the integrated sale and rental of specialized equipment.

What is claimed is:

1. A system for the rental and sale of products comprising:
a storage means comprising at least one container configured to house at least one rental product comprising at least one repository configured to house at least one non-rental product;
a user interface operative to receive a transaction request from a user;
a delivery means operative to deliver the at least one rental product and the at least one non-rental product to the user in response to the transaction request; and
a receiving means configured to receive the at least one rental product; and
a communication means comprising a memory and a processor.

2. The system of claim 1, wherein the at least one container configured to house the at least one rental product is a plurality of locker.

3. The system of claim 1, wherein the at least one rental product is at least one action camera.

4. The system of claim 1, wherein the at least one rental product comprises at least one action camera and at least one rental product accessory.

5. The system of claim 1, wherein the at least one non-rental product is at least one memory card.

6. The system of claim 1, where the user interface further comprises a means for receiving payment.

7. The system of claim 1, wherein the delivery means for the at least one rental product comprises a covering on the at least one container, the covering comprising a latch operative to selectively lock and unlock, wherein the processor transmits a signal to the latch to lock or unlock.

8. The system in claim 7, wherein the receiving means further comprises a product verification means operative to verify that the at least one rental product being received is the same at least one rental product delivered.

9. The system in claim 1, further comprising a power supply, wherein each of the at least one container comprises a charging means coupled with the power supply and operative to charge the at least one rental product housed within.

10. A computer implemented method for dispensing at least one product for sale and one product for rent from a machine comprising the steps of:
by a computer system comprising a processor:
receiving a transaction request;
at a display, displaying at least one rental option and at least one customization option;
in response to receiving a response to the at least one customization option, customizing a transaction;
authenticating the user's identity by receiving a user's identifying information, transmitting an authentication request to a secondary device, and receiving a response to the request to the secondary device operative to authenticate the user;
calculating from the rental option and the at least one customization option a fee; and
receiving a payment; and
by a delivering means:
delivering at least one rental product and at least one non-rental product.

11. The method of claim 10, wherein the at one rental product is at least one action camera.

12. The method of claim 10, wherein the at least one non-rental product is at least one memory card.

13. The method of claim 10, wherein the at least one customization option is selected from a group comprising at least one plan option, a purchase of additional of the at least one non-rental product, an insurance plan, and a rental of additional of the at least one rental product.

14. The method of claim 10, further comprising a step of transmitting to a device associated with the user a receipt comprising the fee and the transaction.

15. The method of claim 9, further comprising executing the return of the at least one rental product to the machine comprising the steps of:
by the computer system:
receiving a return request;
authenticating the user;
at the display, displaying at least one transaction associated with the user, receiving a selection of at least one rental product being returned, and receiving a quality condition of the at least one rental product;
by a receiving means:
receiving the at least one rental product;
responsive to receiving the at least one rental product and by the computer system:
calculating a refund; and
transmitting the refund to the user.

16. The method of claim 14, wherein the steps of authenticating the user comprises:
receiving at the graphical user interface, the user's identifying information; and
verifying that the user's identifying information received corresponds with the user's identifying information.

17. The method of 14, wherein the quality condition comprises damage and receiving a quality condition comprises:
performing the steps of transmitting an inspection request to an administrative device; and
receiving an inspection condition before the step of calculating the refund.

18. The method of 14, further comprising verifying that the at least one rental product received is the at least one rental product being returned.
